(19) United States
(12) Patent Application Publication
(10) Pub. No.: US 2006/0258360 A1
(43) Pub. Date: Nov. 16, 2006

(54) Method and apparatus to allow two way communication to provide time and location specific information

(75) Inventor: J. Timothy Smith, Highlands Ranch, CO (US)

Correspondence Address: HOLLAND & HART, LLP, P.O BOX 8749, DENVER, CO, 80201, US

(73) Assignee: Protecticom Corporation, Highlands Ranch, CO (US)

(21) Appl. No.: 11/430,732

(22) Filed: May 9, 2006

Related U.S. Application Data
(60) Provisional application No. 60/680,260, filed on May 11, 2005.

(51) Int. Cl. H04Q 7/20

(52) U.S. Cl. 455/445; 455/428

(57) ABSTRACT

Realtime or near realtime data is provided by a reporting service to a data aggregator. The data aggregator provides the aggregated data to a network operations center. The aggregated data may be indexed. A mobile device used by a user provides identification information to the network operations center. Such identification information includes location information. The network operation center correlates the identification information with the aggregated data and transmits correlated data to the user via the mobile device such that the user has realtime or near realtime data.

### RELATED APPLICATIONS

This is application claims the benefit of U.S. Provisional Patent Application Ser. No. 60/680,260, filed May 11, 2005, titled METHOD AND APPARATUS TO ALLOW TWO WAY COMMUNICATION TO PROVIDE TIME AND LOCATION SPECIFIC INFORMATION, which is incorporated herein by reference. This application is related to U.S. patent application Ser. No. 10/905,890, titled METHOD AND APPARATUS TO ALLOW CUSTOMERS TO INITIATE CALL CENTER CONTACT, filed Jan. 25, 2005, incorporated herein by reference as if set out in full.

### FIELD OF THE INVENTION

The present invention relates to providing real-time or near real-time, location specific information to a communication device and, more particularly to establishing a two-way communication link between devices to provide real-time or near real-time location specific traffic updates.

### BACKGROUND OF THE INVENTION

According to recent surveys, traffic congestion remains a significant problem in many areas of the country and world. Drivers typically obtain information relating to congestion through radio broadcasts or the like. Drivers obtaining information from the radio tuned to a particular station and typically receive live information from a traffic reporter, either land or air based. The report, however, frequently has little to do with the driver's current location. For example, a driver north of town may be listening to a broadcast regarding a significant accident south of town on the radio. Because the accident south of town is significant, smaller incidents north of town, while known or at least knowable by the reporting service, are not actually reported. Thus, the driver taking a typical route to a destination may inadvertently get detained by the smaller incident that could have been avoided if more time and location specific information had been provided to the driver.

Of course, the general broadcast is designed to provide the greatest good to the greatest number of people, but to the driver stuck in traffic, that is of little consequence.

Moreover, once stuck in traffic, it is frequently difficult to determine new, different, and less congested routes. In part, this is because a number of people begin diverting from the conventional path. The people diverting to alternative roots may increase congestion and incidents on those routes due, in part, to the higher than normal traffic. These alternative route incidents are often derived from more major incidents and frequently go completely unreported. Thus, the information delivery service (such as the traffic reporter) is often unaware of the incident. Even major incidents are normally reported significantly after the fact, as it typically requires a person witnessing (or stuck) in the incident to call in and report the incident to the information service in order to have the information service investigate and report on the same.

Thus, it would be desirable to develop methods, apparatuses, and systems in which the subscriber or customer can receive location and time specific information. Moreover, it would be desirous if the subscriber or customer could provide feedback information to the information providing service to indicate a possible incident and/or confirm a suspected incident.

### SUMMARY OF THE INVENTION

The present invention provides a method for providing two way communication between a user and an information provider. The method includes obtaining raw data from data reporting services and aggregating the raw data into aggregated data. The aggregated data is provided to network operations center that also receives identification information from a user device. The center correlates the aggregated data with the identification information and transmits the aggregate data to the user device when the aggregated data is correlated with the identification information.

The present invention also provides a system to communicate realtime or near realtime data to a user. The system includes a network operations center including a data aggregating database. A mobile device is coupled to the network operations center by a wireless communication link. The data aggregating database receives raw data from reporting services and aggregates the raw data into aggregated data. The mobile device provides identification information to the network operations center. The network operations center uses the aggregated data in the database and transmits the data to a user of the mobile device if the aggregated data and the identification information are correlated.

The foregoing and other features, utilities and advantages of the invention will be apparent from the following more particular description of a preferred embodiment of the invention as illustrated in the accompanying drawings.

### BRIEF DESCRIPTION OF THE DRAWING

The accompanying drawings, which are incorporated in and constitute a part of this specification, illustrate embodiments of the present invention, and together with the description, serve to explain the principles thereof. Like items in the drawings are referred to using the same numerical reference.

FIGS. 1 and 2 are functional block diagrams of a system consistent with an embodiment of the present invention.

### DETAILED DESCRIPTION

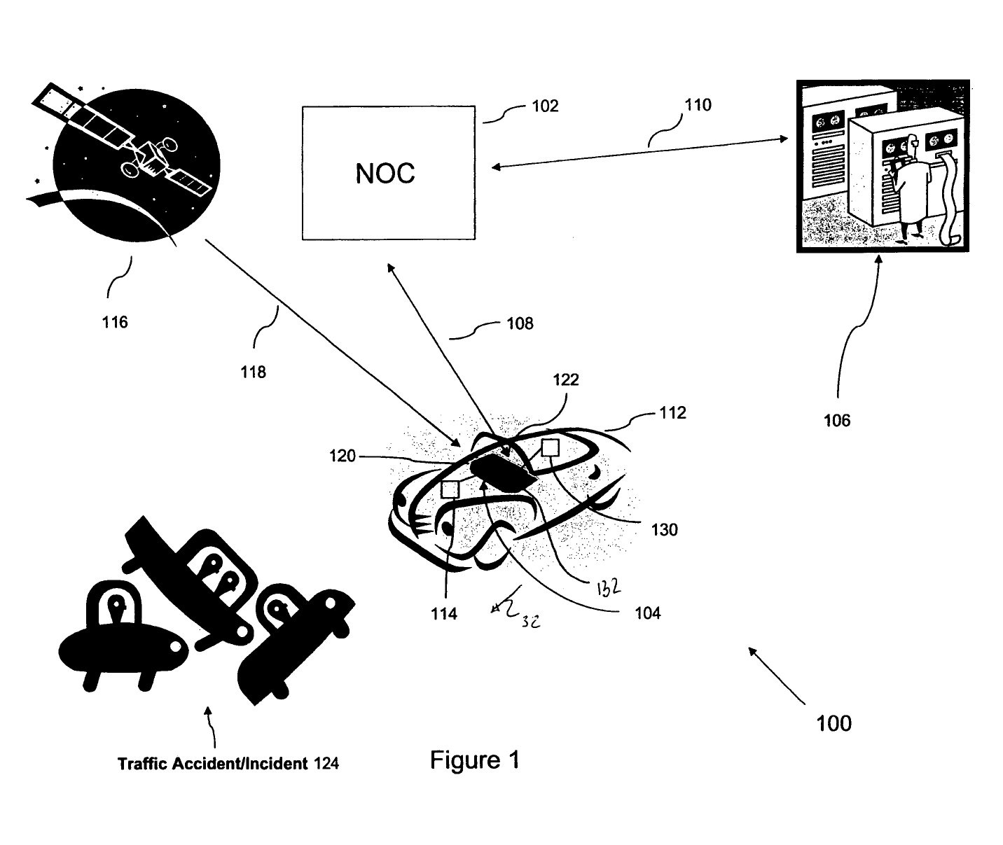

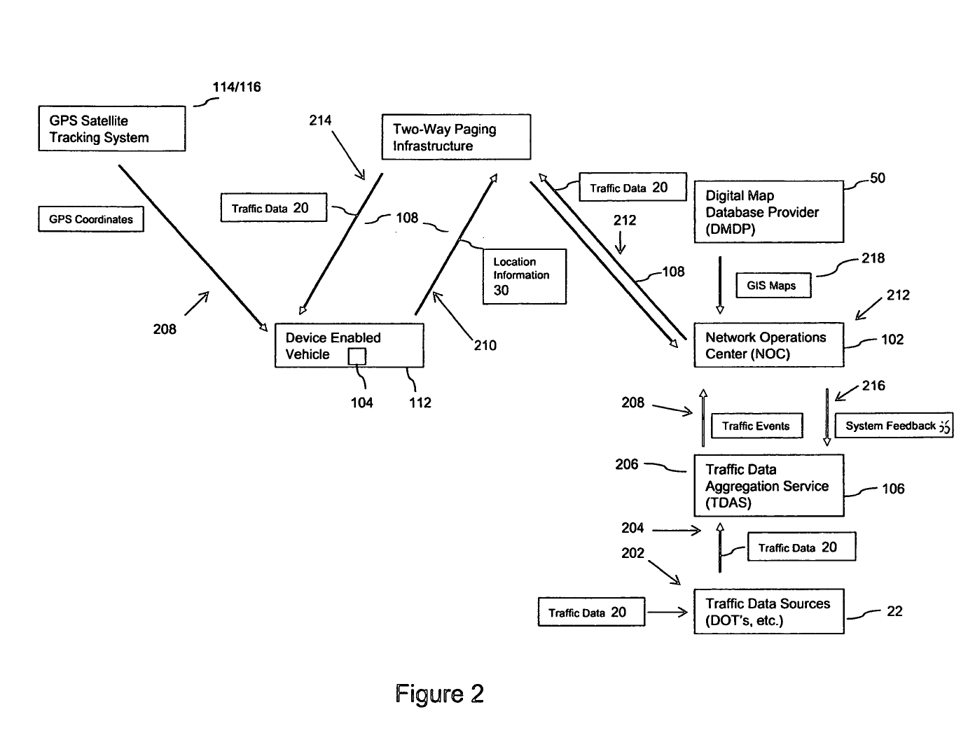

The present invention will be described with reference to FIGS. 1 and 2 While the present invention will be explained in the context of traffic information, both providing information to a driver as well as receiving information from a driver, one of ordinary skill in the art will recognize on reading the disclosure that the present invention can be used in other environments, such as, for example, locating moving objects and providing directions to the object.

Referring now to FIG. 1, a system 100 consistent with the present invention is shown. System 100 includes a network operations center (NOC) 102, a mobile device 104, and an information provider 106. A communication link 108 connects NOC 102 and mobile device 104 and a communication link 110 connects NOC 102 and information provider 106. For convenience, system 100 is described in relation to traffic information. Thus, mobile device 104 is mounted in a vehicle 112, such as, for example, a car (although vehicle could be a bus, truck, railroad car, boat, airplane, or the like). Information provider 106 is a real-time or near real-time traffic data provider.

Communication link 108 connecting NOC 102 and mobile device 104 is wireless. Communication link 108 could be any number of wireless protocols, such as, for example, two-way radio protocols, paging protocols, text messaging protocols, cellphone protocols, or the like. Preferably, communication link 108 uses a ReFLEX two-way paging protocol. A positioning device (PD) 114 may be mounted in vehicle 112 as well. As shown, PD 114 is a satellite 116 based global positioning device (GPD) 114. PD 114 could, however, be a tower based system. The PD 114 could be separate from mobile device 104, as shown, or integrated into mobile device 104. PD 114 and satellites 116 are connected using communication link 118. PD 114 and satellites 116 operate as conventional manners to provide location information for mobile device 104, which information will be used as explained further below. As used herein, one of ordinary skill in the art would recognize that satellites 116 could be replaced with radio frequency towers and the location information could be derived using other conventional methodologies, such as, for example, triangulation. For ease of use, mobile device may include conventional voice recognition modules 120 and text-to-speech modules 122. A display 130, optionally, may be incorporated into vehicle 112 as well.

Referring now to FIG. 2, operation of system 100 will now be explained in more detail. While explained in as a series of steps, one of ordinary skill in the art will recognize on reading the disclosure that many of the steps described are operating in parallel. FIG. 2 shows traffic data 20, such as, for example, accidents (as shown by accident 124 in FIG. 1), high congestion, or the like being identified by traffic data sources 22, step 202. Traffic data sources can be, for example, traffic reports, police reports, individual and independent call in information, or the like. Traffic data sources 22 broadcast the traffic data 20 to the information provider 106, which in the case of traffic, for example, is a traffic data aggregation service (TDAS) 106, step 204. TDAS 106 stores and aggregates or indexes the traffic data 20, step 206. In traffic, aggregating the data may include providing location tags on the raw data reported from the information provider. If the raw data was related to stocks, for example, the aggregating may be based on company capitalization. Other types of aggregating and indexing are available. TDAS 104 transmits traffic data 20 to NOC 102, step 208. Traffic data 20, or traffic events, can be continuously transmitted to NOC 102 and stored by NOC 102 or, alternatively, NOC 102 could request information on an as needed basis. Moreover, TDAS 104 and NOC 102 may be integrated into a single entity.

Substantially at the same time as obtaining, indexing, and storing the traffic data, mobile device 104 in vehicle 114 is continuously or periodically using a signal from the positioning system, for example, satellites 116 to determine its location, step 208. The positioning system may, for example, be a global satellite positioning system where GPD 114 communicates with satellites 116 to determine the position of the vehicle. Location information 30 is communicated to NOC 102 over communication link 108, such as, for example, a two-way paging infrastructure, step 210. Other two-way wireless transmission protocols as are generally known in the art are useable also. Location information 30 could be broadcast continuously or periodically. NOC 102 identifies traffic data related to the location information, step 212, and transmits the traffic data 20 to mobile device 104 over communication link 108. The traffic data could then be displayed on an in car display 130, such as, for example, a digital map, or the text-to-speech module 120 could convert the signal into an audio signal, step 214. If NOC 102 does not store and index the traffic data itself, NOC 102 would perform the additional step of requesting traffic data 20 from information provided 104, step 216.

NOC 102 could be preprogrammed to provide traffic data within a certain radius of location information 30. Alternatively, location information could transmit a user-specified sensitivity. For example, mobile device 104 may have a device 132 to allow the user to select different sensitivities, such as, for example, a 1 mile radius, a 2 mile radius, a 5 miles radius, a 7 mile radius, etc. Device 132 may be one or more toggle switches, a touch screen, keyboard, a graphical user interface, or the like. Still alternatively, NOC 102 could be preprogrammed to return different sensitivities depending on the street. For example, a residential street may provide a sensitivity of 2 miles, while an interstate may provide a sensitivity of 10 miles. Another option would be to provide location information 30 and direction of travel information 32. NOC 102 could deliver traffic data for 6 miles in the direction of travel and, for example, 2 miles in the other directions.

Communication link 110 between information provider 106 and NOC 102 can be any number of conventional connections, such as, for example, telephone, cellular, LAN, WAN, Ethernet, WiFi, wireless, Bluetooth, Internet, or the like. Moreover, information provider 106 could be incorporated into NOC 102 such that communication link 110 may be any conventional bus, coax, ribbon cable, fiber optic, or the like.

NOC 102 also may have a map module 50. Map module 50 would provide geographic map information to NOC 102, step 218. Map module 50 can obtain geographic map information from any of a number of conventional sources. Using map information, NOC 102 can overlay traffic events, street information, and location information to provide traffic data to particular users. Moreover, NOC 102 could provide alternative driving directions based on the map. For example, if main street is blocked by faulty traffic light, and vehicle 114 is traveling north on main street towards the traffic event, NOC 102 may direct vehicle 114 to take a left on detour street, and take a right onto main street parallel. Once past the traffic event, NOC 102 could further direct vehicle 114 to take a right onto return street and a left to continue north on main street.

Finally, mobile device 104 may provide feedback information 35 to NOC 102 and/or information provider 106. For example, if vehicle 112 is traveling down an interstate with an average speed limit of 65 mph, a sudden decrease in speed (which may be indicated by less movement over time by the location information), information provider 106 may use that as traffic data because a sudden drop in speed on the interstate would normally indicate congestion. This type of feedback information could be used as original reporting of traffic data (i.e., new incidents, or confirmation of other reports/predictions).

While the invention has been particularly shown and described with reference to an embodiment thereof, it will be understood by those skilled in the art that various other changes in the form and details may be made without departing from the spirit and scope of the invention.

I claims:

1. A method of providing realtime or near real-time data relative to a user, the method comprising the steps of:
obtaining raw data from data reporting services;
aggregating the raw data from the services into aggregated data;
providing the aggregated data to a network operations center;
receiving at the network operations center identification information from a user device;
correlating the aggregated data with the identification information; and
transmitting the aggregate data to the user device when the aggregated data is correlated with the identification information.

2. The method of claim 1, wherein the raw data comprises traffic information.

3. The method of claim 2, wherein the traffic information is selected from a group of information consisting of: accidents, road work, congestion, or closures.

4. The method of claim 1, further comprising providing the aggregate data to a user of the user device.

5. The method of claim 4, wherein the step of providing the aggregate data to the user includes providing the aggregate data in a format selected from a group of formats consisting of: audio, video, audio-video, images, or audio-images.

6. The method of claim 2, further comprising the step of providing feedback to the network operations center regarding an accuracy of the aggregate data.

7. The method of claim 6, wherein the feedback is provided manually by a user.

8. The method of claim 6, wherein the feedback is provided automatically.

9. The method of claim 7, wherein the feedback provided automatically is based on vehicle operating conditions.

10. The method of claim 2, further comprising the step of providing alternative routes based on the aggregate data to the user device.

11. The method of claim 10, wherein the step of providing alternative routes includes the step of obtaining a map.

12. An apparatus comprising:
a network operations center;
a data aggregating database coupled to the network operation center by a first communication link; and
a mobile device coupled to the network operations center by a wireless communication link,
wherein the data aggregating database receives raw data from reporting services and aggregates the raw data into aggregated data,
the aggregated data is provided to the network operations center,
the mobile device provides identification information to the network operations center,
the network operations center correlates the aggregated data and the identification information and based on a predetermined correlation, transmits the aggregated data to the mobile device.

13. The apparatus according to claim 12, wherein the communication link is a first wireless communication link.

14. The apparatus according to claim 12, wherein the raw data is traffic information selected form the group of information consisting of: accidents, road work, congestion, or closures.

15. The apparatus according to claim 12, wherein the mobile device transmits feedback to the network operations center regarding the aggregate data.

16. The apparatus according to claim 12, wherein the communication link is selected from a group of communication links consisting of: telephone, cellular, LAN, WAN, Ethernet, WiFi, wirelesss, Bluetooth, Internet, ReFlux, or IEEE 802.11.

17. The apparatus according to claim 12, further comprising a positioning determining device.

18. The apparatus according to claim 17, wherein the positioning determining device is a global positioning satellite device.
